(19) United States
(12) Patent Application Publication
(10) Pub. No.: US 2013/0017321 A1
(43) Pub. Date: Jan. 17, 2013

(54) METHOD FOR FORMING A METAL MESH ELECTRODE OF A TOUCH PANEL

(71) Applicants: Young Jae Kim, Gyunggi-do (KR); Ha Yoon Song, Gyunggi-do (KR); Ho Joon Park, Seoul (KR)

(72) Inventors: Young Jae Kim, Gyunggi-do (KR); Ha Yoon Song, Gyunggi-do (KR); Ho Joon Park, Seoul (KR)

(73) Assignee: SAMSUNG ELECTRO-MECHANICS CO., LTD., Gyunggi-do (KR)

(21) Appl. No.: 13/251,998

(22) Filed: Oct. 3, 2011

(30) Foreign Application Priority Data
Jul. 13, 2011 (KR) 1020110069534

(51) Int. Cl. B05D 5/12; B05D 3/00

(52) U.S. Cl. 427/108

(57) ABSTRACT

A method for forming a metal mesh electrode of a touch panel of the present invention can solve a depletion problem of resources used for a transparent conductive layer by forming an electrode using a metal thin film on which fine patterns are formed, instead of using ITO and form a metal mesh electrode having a fine line width while controlling a height by using a screen printing method using a photoresist layer and a printing mask together.

### CROSS REFERENCE TO RELATED APPLICATION

This application claims the benefit of Korean Patent Application No. 10-2011-0069534, filed on Jul. 13, 2011, entitled “METHOD FOR FORMING A METAL MESH ELECTRODE OF A TOUCH PANEL”, which is hereby incorporated by reference in its entirety into this application.

### BACKGROUND OF THE INVENTION

1. Technical Field

The present invention relates to a method for forming a metal mesh electrode of a touch panel.

2. Description of the Related Art

As a computer using a digital technology is developed, accessory devices of the computer have also been developed. A personal computer, a portable transmission device, and other personal only information processing devices, or the like, perform text and graphic processing using various input devices such as a keyboard, a mouse, or the like.

However, as an information-oriented society is rapidly progressed, a usage of the computer has gradually expanded. It is difficult to efficiently drive products only by the keyboard and the mouse serving as the present input devices. Therefore, a need for devices that are simple and have little malfunction while allowing anyone to easily input information is increased.

In addition, a technology for an input device has been evolved to a technology of high reliability, durability, innovation, design and machining, or the like, including a technology of satisfying general functions. In order to achieve the above objects, a touch panel as an input device capable of inputting information such as text, graphic, or the like, has been developed.

The touch panel is installed on a display surface of a flat panel display, such as an electronic notebook, a liquid crystal display device (LCD), a plasma display panel (PDP), electroluminescence (El), or the like, and an image display device, such as a cathode ray tube (CRT), which is a tool used for a user to select desired information while watching an image display device.

Meanwhile, a demand for a transparent conductive layer material has also increased with a sudden expansion of a thin display field business, centering around an LCD. As the transparent conductive layer material, indium tin oxide (ITO) has been mainly used. When considering the rising demand for applications due to excellent characteristics of the ITO as a transparent electrode, it is expected that the consumption of the material is gradually increased in the future. However, indium forming the ITO is one of representative scarce and depleted resources and the supply thereof is greatly reduced. According to the specialist, it is expected that the indium is fully exhausted from about 10 to about 25 years. The indium needs to be purified using by-products of a zinc ore, which also leads to high scarcity. Even before the indium is depleted, the sudden rise in indium price leads to increase manufacturing costs of applications. Therefore, a development of a new transparent conductive layer that does not include the indium is very urgently needed.

### SUMMARY OF THE INVENTION

The present invention has been made in an effort to provide a method for forming a metal mesh electrode capable of solving a depletion problem of resources used for a transparent conductive layer by forming an electrode using a metal thin film on which fine patterns are formed, instead of using ITO. In particular, the present invention has been made in an effort to provide a method for forming a metal mesh electrode capable of having a fine line width while controlling a height by using a screen printing method using a photoresist layer and a printing mask together.

According to a preferred embodiment of the present invention, there is provided a method for forming a metal mesh electrode of a touch panel, including: (A) applying a photoresist layer to a transparent substrate; (B) forming a photoresist pattern having a first opening part in a mesh shape by patterning the photoresist layer; (C) disposing a printing mask on the patterned photoresist layer, the printing mask being formed at a position corresponding to the first opening part and having a second opening part formed to have a width wider than a width of the first opening part; and (D) forming a metal mesh electrode by printing a metal paste on the second opening part of the printing mask and the first opening part of the photoresist layer.

Step (B) may include: (B1) disposing a photomask on the photoresist layer; and (B2) selectively exposing and developing the photoresist layer.

At step (C), the second opening part of the printing mask may expose the first opening part of the photoresist layer and a portion of the photoresist layer around the first opening part.

Step (D) may include: (D1) filling the second opening part of the printing mask and the first opening part of the photoresist layer with the metal paste; (D2) hardening or firing the metal paste after removing the printing mask; and (D3) forming the metal mesh electrode by removing the metal paste printed just above the photoresist layer together with the photoresist layer and leaving the metal paste directly contacting the transparent substrate on the transparent substrate, by delaminating the photoresist layer from the transparent substrate.

A height of the metal mesh electrode of step (D) may be formed to correspond to a thickness of the photoresist layer.

The height of the metal mesh electrode of step (D) may be formed from more than the thickness of the photoresist layer to less than a sum of the thickness of the photoresist layer and the thickness of the printing mask.

The metal mesh electrode of step (D) may be formed to have the same width as the width of the first opening part of the photoresist layer.

### BRIEF DESCRIPTION OF THE DRAWINGS

FIGS. 1 to 6 are plan views and cross-sectional views showing a process sequence of a method for forming a metal mesh electrode according to a preferred embodiment of the present invention.

### DESCRIPTION OF THE PREFERRED EMBODIMENTS

Various features and advantages of the present invention will be more obvious from the following description with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. Further, when it is determined that the detailed description of the known art related to the present invention may obscure the gist of the present invention, the detailed description thereof will be omitted. Hereinafter, preferred embodiments of the present invention will be described in detail with reference to the accompanying drawings.

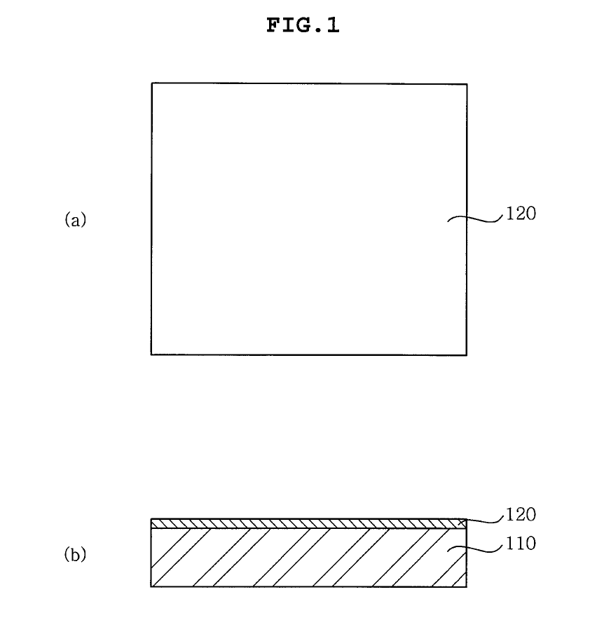

FIGS. 1 to 6 are plan views and cross-sectional views showing a process sequence of a method for forming a metal mesh electrode 155 according to a preferred embodiment of the present invention. The preferred embodiment of the present invention relates to a method for forming a metal electrode using a screen printing method and a lift-off method together. The method for forming the metal mesh electrode 155 will be described below with reference to FIGS. 1 to 6.

First, as shown in FIG. 1, a photoresist layer 120 is applied to a transparent substrate 110.

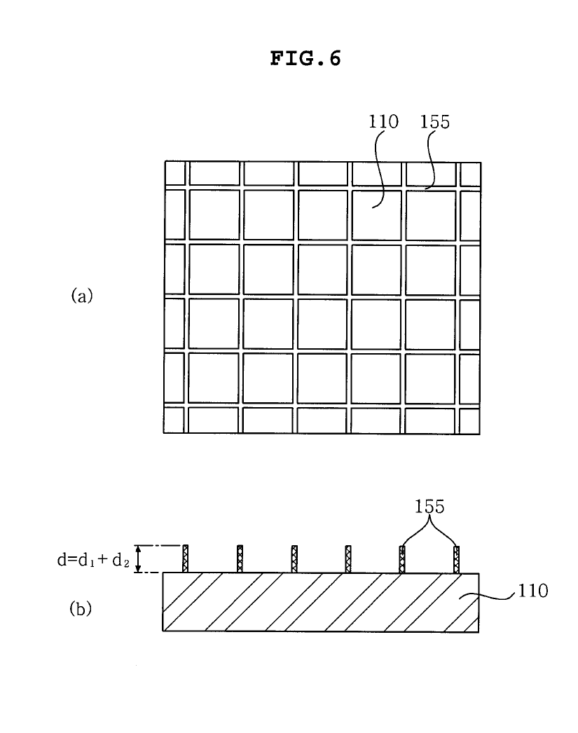

The transparent substrate 110 serves to provide an area in which the metal mesh electrode 155 (see FIG. 6) and electrode wirings (not shown) are formed. Herein, the transparent substrate 110 is partitioned into an active area and a bezel area. The active area is a portion in which the metal electrode is formed so as to recognize a touch of input units and is provided at a center of the transparent substrate 110 and the bezel area is a portion in which the electrode wirings extending from the metal electrode are formed and is provided at an edge of the active area. In this case, the transparent substrate 110 needs to have a support force capable of supporting the metal mesh electrode 155 and the electrode wirings (not shown) and transparency allowing a user to recognize images provided on an image display device (not shown). When the above-mentioned support force and transparency, the material of the transparent substrate 110 may be made of polyethylene terephthalate (PET), polycarbonate (PC), poly methyl methacrylate (PMMA), polyethylene naphthalate (PEN), polyethersulpon (PES), cyclic olefin polymer (COC), triacetylcellulose (TAC) film, polyvinyl alcohol (PVA) film, polyimide (PI) film, polystyrene (PS), biaxially stretched polystyrene (K resin containing biaxially oriented PS; BOPS), glass, or tempered glass, but is not necessarily thereto.

Meanwhile, in the final structure (see FIG. 6) of the preferred embodiment of the present invention, the metal mesh electrode 155 formed on the transparent substrate 110 may be formed to have a line width of 10 μm or less, but the line width is not necessarily limited thereto. The photoresist layer 120 used for the preferred embodiment of the present invention is a component used for finely forming the line width of the metal mesh electrode 155 up to 10 μm. That is, when using a method for disposing the generally used printing mask 140 on the transparent substrate 110 and then, printing a metal paste 150 through a second opening part 145 formed on the printing mask 140, a height of the printed metal paste 150 may be controlled, but the metal mesh electrode 155 having the line width of 10 μm or less may not be implemented. For this reason, the printing mask 140 is used to ensure a height d of the metal mesh electrode 155. The photoresist layer 120 is interposed between the printing mask 140 and the transparent substrate 110 so as to form the metal mesh electrode 155 having a fine line width. The role of the photoresist layer 120 will be described in detail in the following process. As a method for forming the photoresist layer 120 on the transparent substrate 110, a dry film method or a liquid photosensitive method may be used. The dry film method is a method that thermally compresses a dry film on one surface of the transparent substrate 110 using a laminator and the liquid photosensitive method is a method that coats and dries a liquid photosensitive material photosensitized by ultraviolet (UV) rays on the transparent substrate 110. As the currently well-known coating method, there are a screen coating method, a dip coating method, a roll coating method, an electro deposition method, or the like.

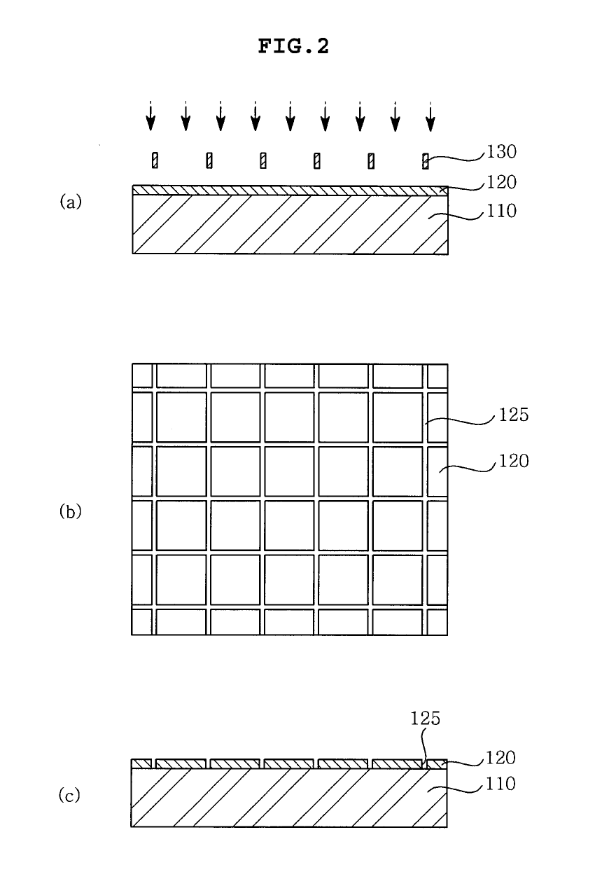

Next, as shown in FIG. 2, a portion of the transparent substrate 110 is exposed by patterning the photoresist layer 120 to form a photoresist pattern having the first opening part 125 in a mesh shape. The preferred embodiment of the present invention uses a negative type photoresist to form the photoresist layer 120. The present process will be described in detail in connection therewith.

A photomask 130 on which a predetermined pattern is formed is provided and the photomask 130 is closely adhered or close to the top of the photoresist layer 120. Thereafter, a light source is disposed at a position spaced apart from the photomask 130 and ultraviolet rays emitted from the light source are irradiated to the photoresist layer 120 to selectively expose the photoresist layer 120. In this case, the photomask 130 is provided with patterns having a mesh structure, which results in selectively transmitting the ultraviolet rays (UV). A portion of the photoresist layer 120 that is exposed to the ultraviolet rays is hardened by polymerization reaction and the remaining portions thereof are not changed. Next, due to the development of the photoresist layer 120, the hardened portion exposed to the ultraviolet rays remains on the transparent substrate 110 and the non-hardened portion is removed by being dissolved in a developer. When the non-hardened portion of the photoresist layer 120 is selectively removed, the photoresist layer 120 is provided with the first opening part 125. In this case, the first opening part 125 of the photoresist layer 120 has the mesh structure in which the line width is generally about 10 μm. In addition, in order to removing the developer, or the like, remaining on the transparent substrate 110 after developing, washing and drying processes may be performed. In addition, a method for forming the photoresist layer using the negative type photoresist and the positive type photoresist belongs to the scope of the present invention.

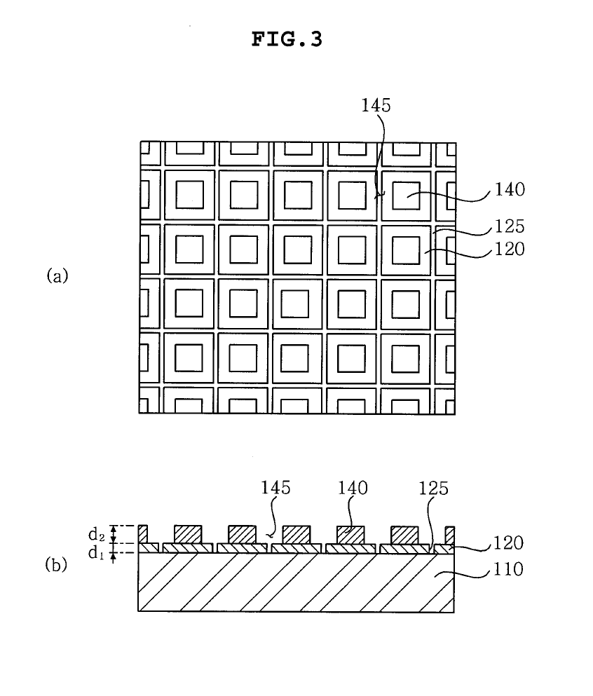

Next, as shown in FIG. 3, the printing mask 140 is disposed on the photoresist layer 120. As the printing mask 140, a metal screen formed to have any shape by machining a thin type metal plate using etching or laser machining may be used. Meanwhile, the metal screen made of a stainless steel material is mainly used. In this case, the printing mask 140 is provided with the to second opening part 145 having a predetermined pattern and the shape of the second opening part 145 of the printing mask 140 is formed to correspond to a position of the first opening part 125 of the photoresist layer 120. The first opening part 125 of the photoresist layer 120 may be the mesh structure in which the line width is about 10 μm and the shape of the second opening part 145 of the printing mask 140 may be a mesh structure in which the line width is about 100 μm That is, the first opening part 125 and the second opening part 145 are formed at the corresponding position to each other, but the line width thereof may be different from each other. The reason is that the printing mask 140 used for the screen printing method may not be provided with the second opening part 145 having the line width of about 10 μm. Reviewing the disposition structure of the photoresist layer 120 and the printing mask 140 disposed on the photoresist layer 120, the line width of the second opening part 145 is wider than that of the first opening part 125, such that the first opening part 125 of the photoresist layer 120 and a portion of the photoresist layer 120 around the first opening part 125 are exposed through the second opening part 145 of the printing mask 140. As shown in FIG. 3, a thickness of the printing mask 140 is defined by d1 and a thickness of the photoresist layer 120 is defined by d2.

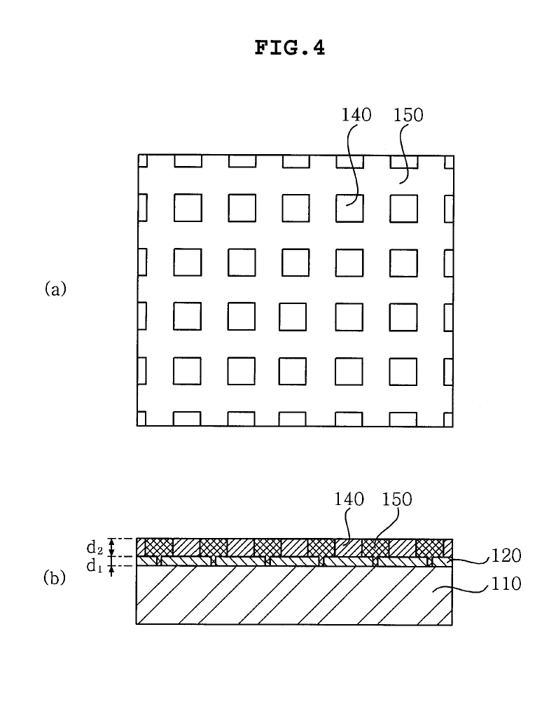

Next, as shown in FIG. 4, the second opening part 145 of the printing mask 140 and the first opening part 125 of the photoresist layer 120 are filled and printed with the metal paste 150 by using the screen printing method. As shown in FIG. 3, the printing mask 140 is disposed on the photoresist layer 120, the first opening part 125 corresponds to the second opening part 145, and the shape of the metal paste 150 printed and filled on the second opening part 145 and the first opening part 125 has a “T”-letter shape since the line width of the second opening part 145 is wider than that of the first opening part 125. That is, in the T-shaped metal paste 150, a pillar portion (vertical portion) contacts the transparent substrate 110 exposed by the first opening part 125 and a wing portion (horizontal portion) contacts the photoresist layer 120 exposed by the second opening part 145 of the printing mask 140. The height d of the metal paste 150 is larger than the thickness d1 of the photoresist layer 120 and is formed to be less than a sum of the thickness d1 of the photoresist layer 120 and the thickness d2 of the printing mask 140. Meanwhile, as described below, the metal paste 150 contacting the photoresist layer 120 exposed by the second opening part 145 is a portion removed by the delamination of the photoresist layer 120. Meanwhile, as the metal paste 150, gold (Au), silver (Ag), palladium (Pd), platinum (Pt), aluminum (Al), copper (Cu), nickel (Ni), tin (Sn), and an alloy thereof may be used.

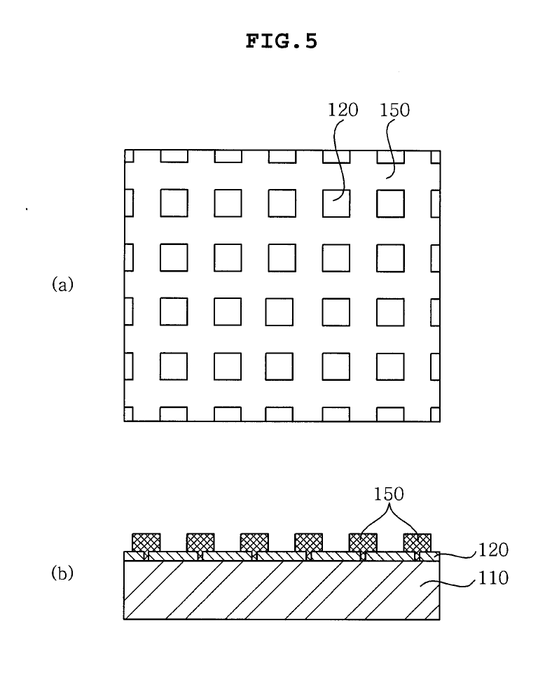

Next, as shown in FIG. 5, after removing the printing mask 140 from the photoresist layer 120, the metal paste is hardened or fired. As shown in FIG. 6, the photoresist layer 120 is removed from the transparent substrate 100 by delamination.

After removing the printing mask 140 from the photoresist layer 120, the metal paste is hardened at 120° C. to 180° C. for 20 to 40 minutes. More preferably, the metal paste may be hardened at 150° C. for 30 minutes.

When the photoresist layer 120 is delaminated from the transparent substrate 110, the photoresist layer 120 is filled through the second opening part 145, such that the photoresist layer 120 is removed together with the metal paste 150 formed just above the photoresist layer 120. That is, in the “T”-shaped metal paste 150, the wing portion (horizontal portion) is removed and thus, only the pillar portion (vertical portion) remains on the transparent substrate 110, thereby forming the metal mesh electrode 155. The line width of the metal mesh electrode 155 is the same as the line width of the first opening part 125 of the photoresist layer 120 and the height d of the metal mesh electrode 155 may be formed to correspond to the thickness d1 of the photoresist layer 120. However, when the height d of the metal mesh electrode 155 exceeds the thickness d1 of the photoresist layer 120, the height d of the metal mesh electrode 155 may be formed at a height less than the sum of the thickness d1 of the photoresist layer 120 and the thickness d2 of the printing mask 140. In other words, the line width of the last formed metal mesh electrode 155 may be finely formed on the transparent substrate 110 by forming the first opening part 125 on the photoresist layer 120. In addition, it is possible to easily control the height of the metal mesh electrode 155 by appropriately selecting the thickness d2 of the printing mask 140. Further, when the metal mesh electrode 155 is formed by a metal deposition method, vacuum deposition equipment is required and in order to form the metal mesh electrode 155 at a predetermined height or more, since a repetitive deposition process needs to be performed, the manufacturing cost of the metal mesh electrode 155 is increased. On the other hand, the preferred embodiment of the present invention can save the manufacturing costs by applying the screen printing method using both of the photoresist layer 120 and the printing mask 140. When removing the photoresist layer 120, the photoresist layer 120 may be removed in an acetone bath by ultrasonication. In this case, stress is concentrated to the T-shaped wing portion (horizontal portion), such that the wing portion is removed like being torn.

As set forth above, the preferred embodiment of the present invention can form the metal mesh electrode in the first opening part formed on the photoresist layer, thereby finely forming the line width of the metal mesh electrode by controlling the line width of the first opening part.

In addition, the preferred embodiment of the present invention screen-prints the metal paste by disposing the printing mask on the photoresist layer to control the thickness of the printing mask, thereby controlling the height of the metal mesh electrode.

Further, the preferred embodiment of the present invention uses the screen printing method, thereby forming the metal mesh electrode having the fine patterns while controlling the height, at the low manufacturing costs.

Although the embodiment of the present invention has been disclosed for illustrative purposes, it will be appreciated that a method for manufacturing a touch panel according to the invention is not limited thereby, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A method for forming a metal mesh electrode of a touch panel, comprising:
(A) applying a photoresist layer to a transparent substrate;
(B) forming a photoresist pattern having a first opening part in a mesh shape by patterning the photoresist layer;
(C) disposing a printing mask on the patterned photoresist layer, the printing mask being formed at a position corresponding to the first opening part and having a second opening part formed to have a width wider than a width of the first opening part; and
(D) forming a metal mesh electrode by printing a metal paste on the second opening part of the printing mask and the first opening part of the photoresist layer.

2. The method as set forth in claim 1, wherein step (B) includes:
(B1) disposing a photomask on the photoresist layer; and
(B2) selectively exposing and developing the photoresist layer.

3. The method as set forth hi claim 1, wherein at step (C), the second opening part of the printing mask exposes the first opening part of the photoresist layer and a portion of the photoresist layer around the first opening part.

4. The method as set forth in claim 1, wherein step (D) includes:
(D1) filling the second opening part of the printing mask and the first opening part of the photoresist layer with the metal paste;
(D2) hardening or firing the metal paste after removing the printing mask; and
(D3) forming the metal mesh electrode by removing the metal paste printed just above the photoresist layer together with the photoresist layer and leaving the metal paste directly contacting the transparent substrate on the transparent substrate, by delaminating the photoresist layer from the transparent substrate.

5. The method as set forth in claim 1, wherein a height of the metal mesh electrode of step (D) is formed to correspond to a thickness of the photoresist layer.

6. The method as set forth in claim 1, wherein the height of the metal mesh electrode of step (D) is formed from more than the thickness of the photoresist layer to less than a sum of the thickness of the photoresist layer and the thickness of the printing mask.

7. The method as set forth in claim 1, wherein the metal mesh electrode of step (D) is formed to have the same width as the width of the first opening part of the photoresist layer.
